(19) United States
(12) Patent Application Publication
(10) Pub. No.: US 2018/0221916 A1
(43) Pub. Date: Aug. 9, 2018

(54) MULTI-LAYERED SHEET COMPRISING GRAPHENE-BASED BARRIER COATING

(71) Applicant: HEWLETT-PACKARD DEVELOPMENT COMPANY, L.P., HOUSTON, TX (US)

(72) Inventors: KUAN-TING WU, TAIPEI CITY (TW); CHI-HAO CHANG, TAIPEI CITY (TW); WEI-CHUNG CHEN, NEW TAIPEI CITY (TW)

(21) Appl. No.: 15/758,109

(22) PCT Filed: Oct. 29, 2015
(86) PCT No.: PCT/CN2015/093171

§ 371 Date: Mar. 7, 2018

(51) Int. Cl. B05D 7/00; C25D 11/02; C25D 11/30

(52) U.S. Cl. CPC B05D 7/57; B05D 3/067; C25D 11/30; C25D 11/026

(57) ABSTRACT

The present invention relates to a multi-layered sheet comprising Mg-based alloy substrate, micro-arc oxidized layers formed on two opposite surfaces of the Mg-based alloy substrate and graphene-based barrier coating on either one or both of the micro-arc oxidized layers, wherein said graphene-based barrier coating comprises 20-70 wt % of graphene based on the total weight of the graphene-based barrier coating, a process for preparing the multi-layered sheet and the use of the multi-layered sheet as a housing in laptop, tablet PC, desktop computer, smart phone and 3C electronic devices.

### BACKGROUND

Mg-based alloy, as a green, environmental-friendly alloy material, has a low density, high strength and rigidity and it is also well-known for its heat and electrical conductivity, and the ease to be cut and molded. Due to the above properties, Mg-based alloy now becomes a popular material for use as a housing of electronic products, such as laptop, tablet PC, desktop computer, smart phone and 3C electronic devices.

Meanwhile, it is also known that the electrode potential of Mg is very low, about −2.36 V, and renders Mg easily to get corrosion in various media, which may limit the possible application of Mg-based alloy in certain areas. In order to improve the corrosion-resistance of Mg-based alloy, micro-arc oxidation (known as MAO), as a recently developing surface-treatment technology, has been used to treat the Mg-based alloy.

MAO is an electrochemical surface treatment process for generating oxide coating on metals. It is similar to anodizing, but it employs higher potentials, for example, in the MAO of aluminum, at least 200 V must be applied, and the generated oxide is partially converted from amorphous alumina into crystalline forms such as α-Al₂O₃ which is much harder. As a result, mechanical properties as such wear resistance and toughness are enhanced. When the Mg-based alloy substrate is undergone with MAO treatment, micro-arc oxidized layers will be formed on the Mg-based alloy substrate, and correspondingly the corrosion-resistance of Mg-based alloy substrate will be highly improved.

### BRIEF DESCRIPTION OF THE DRAWINGS

The present inventors have found that after micro-arc treatment is carried out to Mg-based alloy substrate, when graphene-based barrier coating is further applied on one or both of the micro-arc oxidized layers of the Mg-based alloy substrate, the resulting sheet can have high pencil hardness, stain and solvent resistance to a wide range of stains, which makes it even more suitable for use as a housing of laptop, tablet PC, desktop computer, smart phone and 3C electronic devices.

FIG. 1 shows an illustrative structure of an example of the multi-layered sheet of the present disclosure, which includes Mg-based alloy substrate, two micro-arc oxidized layers, two graphene-based barrier coatings and a top coat.

FIG. 2 shows an illustrative structure of an example of the multi-layered sheet of the present disclosure, which includes Mg-based alloy substrate, two micro-arc oxidized layers, two graphene-based barrier coatings, a base coat and a top coat.

FIG. 3 shows an illustrative structure of an example of the multi-layered sheet of the present disclosure, which includes Mg-based alloy substrate, two micro-arc oxidized layers, one graphene-based barrier coating, a base coat and a top coat.

FIG. 4 shows an illustrative structure of an example of the multi-layered sheet of the present disclosure, which includes Mg-based alloy substrate, two micro-arc oxidized layers, two graphene-based barrier coatings, and a UV coating.

FIG. 5 shows an illustrative structure of an example of the multi-layered sheet of the present disclosure, which includes Mg-based alloy substrate, two micro-arc oxidized layers, one graphene-based barrier coating, and a UV coating.

FIG. 6 shows an illustrative structure of an example of the multi-layered sheet of the present disclosure, which includes Mg-based alloy substrate, two micro-arc oxidized layers, one graphene-based barrier coating, a base coat and a UV coating.

FIG. 7 is an example flowchart showing the preparation of the multi-layered sheet of the present disclosure.

### DETAILED DESCRIPTION

Improving the performance in hardness, chemical resistance and durability can be realized for MAO-treated Mg-based alloy substrate when graphene-based barrier coating is further applied to one or both of the micro-arc oxidized layers.

In addition, a base coat can be further applied to the graphene-based barrier coating or the micro-arc oxidized layer. A top coat and/or a UV coating can be further applied to the graphene-based barrier, the micro-arc oxidized layer, or the base coat, such as for achieving desired color and ideal gloss.

Mg-based alloy used in the present disclosure can include any commonly used Mg-based alloy in the art. For example, Mg-based alloy with a magnesium content more than 85 wt % may be used in the present disclosure, and it may also contain aluminum, lithium, titanium, zinc and etc. The non-limiting examples for the Mg-based alloy may be MgAZ 91, MgAZ 31, MgLi 91, MgLi 141. After it is undergone with MAO surface-treatment, the Mg-based alloy can be improved in terms of its color stability, hardness and chemical resistance.

In the MAO surface-treatment in the present disclosure, the formed micro-arc oxidized layers are a chemical conversion of the metal substrate into its oxide, and grows both inwards and outwards from the original metal surface. Because it is a conversion coating, rather than a deposited coating (such as a coating formed by plasma spraying), it has better adhesion to the metal substrate.

In the present disclosure, the electrolyte used in electrolytic solution during the MAO surface-treatment can be any common electrolyte known to one skilled in the art, and its non-limiting examples can comprise electrolyte selected from the group consisting of sodium silicate, sodium phosphate, potassium fluoride, potassium hydroxide, sodium hydroxide, fluorozirconate, sodium hexametaphosphate, sodium fluoride, ferric ammonium oxalate, phosphoric acid salt, polyethylene oxide alkylphenolic ether, and combinations thereof. The auxiliary substance for the electrolyte can be further added, such as silicon dioxide powder, aluminum oxide powder, and so on. During the MAO surface treatment, the electrolyte may be present in a concentration of 0.05 to 15% by weight based on the total weight of the electrolytic solution and a voltage in the range of 150-450 V may be passed across the electrolytic solution with the Mg-based alloy substrate placed in it to form the micro-arc oxidized layers. In one example of the present disclosure, the voltage may be applied for about 3 to 20 minutes.

As a crystalline allotrope of carbon, graphene is more than 200 times stronger than steel by weight, conducts heat and electricity efficiently and is nearly transparent. Due to its tightly packed carbon atoms and a sp² orbital hybridization, graphene has a very high stability. Graphene also has a high aspect ratio, such as 50 to 5,000. All of these properties make it suitable to be formulated as a barrier coating layer against corrosion. In the present disclosure, a graphene-based barrier coating can be applied to one or both of the micro-arc oxidized layers on the Mg-based alloy substrate so as to prepare a multi-layered sheet that is intended for a housing of laptop, tablet PC, desktop computer, smart phone, 3C electronic devices and other electronic products.

In the present disclosure, the graphene-based barrier coating can be prepared from a formulation comprising 20-70 wt % of graphene by spray coating or dip coating. In an example of the present disclosure, the graphene contents can vary from 45 to 50 wt % based on the total weight of the formulation. In addition to the graphene, said formulation may comprise polymers selected from the group consisting of epoxy-based polymer, acrylics polymer, polyurethane, acrylic-polyurethane hybrid polymer, fluorine-containing polymers and combinations thereof.

Epoxy-based polymer is often described by the type of central organic moiety or moieties to which the 1,2-epoxy moieties are attached. Non-exclusive examples of such central moieties are those derived from bisphenol A, bisphenol F and their analogs; novolac condensates of formaldehyde with phenol and substituted phenols and their amino analogs. The non-limiting epoxy-based polymer includes glycidyl ethers of a polyhydric phenol, such as bisphenol A (a particularly preferred species of polyhydric phenol), bisphenol F, bisphenol AD, catechol, resorcinol, and the like.

Acrylics polymer will be understood by those of skill in the art to include polymers containing acrylic acid, methacrylic acid, acrylic ester, and methacrylic ester based monomers, and mixtures thereof.

Suitable monomers for acrylics polymer can be esters of (meth)acrylic acid and of acrylic acid, such as alkyl(meth)acrylates of straight-chain, branched, or cycloaliphatic alcohols having 1 to 40 carbon atoms, for example, methyl (meth)acrylate, ethyl (meth)acrylate, n-butyl (meth)acrylate, isobutyl (meth)acrylate, t-butyl (meth)acrylate, 2-ethylhexyl (meth)acrylate, cyclohexyl (meth)acrylate; hydroxyfunctionalized (meth)acrylates, such as 3-hydroxypropyl (meth)acrylate, 3,4-dihydroxybutyl mono(meth)acrylate, 2-hydroxyethyl (meth)acrylate, 4-hydroxybutyl (meth)acrylate, 2-hydroxypropyl (meth)acrylate, 2,5-dimethyl-1,6-hexanediol mono(meth)acrylate; ether-containing (meth)acrylates such as tetrahydrofurfuryl (meth)acrylate, 1-butoxypropyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol)methyl ether (meth)acrylate, and poly(propylene glycol)methyl ether (meth)acrylate.

In the present disclosure, a “polyurethane” is understood to mean a polymer which has at least two urethane groups —NH—CO—O— which connect the segments of the macromolecule, and it can be prepared by reacting at least one polyol, with at least one polyisocyanate in the presence of at least one solvent. A “polyol”, in the present disclosure, is understood to mean a polymer which has at least two OH groups. In principle, various polymers which bear at least two OH groups may be referred to as polyols, such as polyether polyols. Mixtures of various polyols may also be included. A polyisocyanate, in the present disclosure, is understood to mean a compound which has at least two isocyanate groups —NCO. This compound does not have to be a polymer, and instead is frequently a low-molecular compound. The polyisocyanate may be a diisocyanate.

Examples of suitable diisocyanates in the present disclosure may include ethylene diisocyanate, 1,4-tetramethylene diisocyanate, 1,4-tetramethoxybutane diisocyanate, 1,6-hexamethylene diisocyanate (HDI), cyclobutane-1,3-diisocyanate, cyclohexane-1,3- and -1,4-diisocyanate, bis(2-isocyanatoethyl)fumarate, 1-isocyanato-3,3,5-trimethyl-5-isocyanatomethylcyclohexane (isophorone diisocyanate, IPDI), 2,4- and 2,6-hexahydrotoluylene diisocyanate, hexahydro-1,3- or -1,4-phenylene diisocyanate, benzidine diisocyanate, naphthalene-1,5-diisocyanate, 1,6-diisocyanato-2,2,4-trimethylhexane, 1,6-diisocyanato-2,4,4-trimethylhexane, xylylene diisocyanate (XDI), tetramethylxylylene diisocyanate (TMXDI), 1,3- and 1,4-phenylene diisocyanate, 2,4- or 2,6-toluylene diisocyanate (TDI), 2,4′-diphenylmethane diisocyanate, 2,2′-diphenylmethane diisocyanate, or 4,4′-diphenylmethane diisocyanate (MDI), and the isomeric mixtures thereof.

In the present disclosure, the thickness of each layer in the multi-layered sheet can vary. Normally, the thickness of the Mg-based alloy substrate may be in the range of 0.5-20 mm, the thickness of the micro-arc oxidized layer may be in the range of 3-25 μm, and the thickness of the graphene-based barrier coating may be in the range of 5 to 15 μm. The top coat, if existing, may have a thickness of 10 to 25 μm. The base coat, if existing, may have a thickness of 5 to 15 μm. The UV coating, if existing, may have a thickness of 10 to 25 μm.

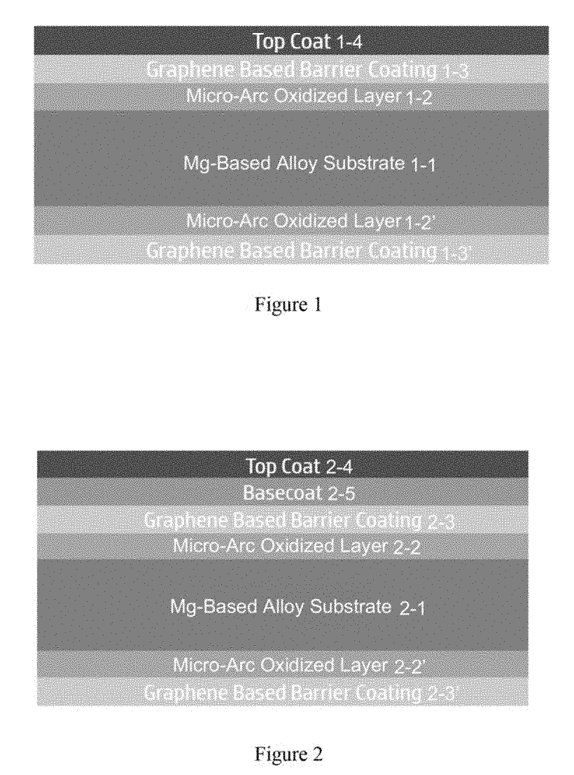

As can be seen clearly from FIG. 1, it is a specific example of one configuration of the multi-layered sheet of the present disclosure, which includes Mg-based alloy substrate 1-1, after being subjected to MAO surface treatment, micro-arc oxidized layer 1-2 and micro-arc oxidized layer 1-2′ are formed on two opposite surfaces of the Mg-based alloy substrate 1-1. Then, graphene based barrier coating 1-3 and graphene based barrier coating 1-3′ are formed respectively on each micro-arc oxidized layer 1-2 and 1-2′. Finally, a top coat 1-4 is formed on graphene based barrier coating 1-3.

The top coat may be prepared either by thermal curing or by UV curing. In addition to base resin polymers such as polyurethane and/or acrylics, the top coat may contain silicas, which are favorable for the gloss control of the multi-layered sheet, and fluoropolymers, such as poly(vinylidene fluoride), polytetrafluoroethylene, fluorinated olefin-based polymers, fluoroacrylates, fluorosilicone acrylates, fluorourethanes, perfluoropolyethers, perfluoropolyoextanes, fluorotelomers (C-6 or lower), fluorosiloxane and/or fluoro UV polymers, which are favorable for the hydrophobic property and the increase of surface smoothness of the multi-layered sheet. In addition, the top coat may contain the functions in anti-finger printing, anti-bacteria or soft touch feeling.

As being shown in FIG. 2, it is a specific example of one configuration of the multi-layered sheet of the present disclosure, which includes Mg-based alloy substrate 2-1, after being subjected to MAO surface treatment, micro-arc oxidized layer 2-2 and micro-arc oxidized layer 2-2′ are formed on two opposite surfaces of the Mg-based alloy substrate 2-1. Then, graphene-based barrier coating 2-3 and graphene-based barrier coating 2-3′ are formed respectively on each micro-arc oxidized layer 2-2 and 2-2′. A base coat 2-5 is then prepared on graphene-based barrier coating 2-3, and finally a top coat 2-4 is formed on the base coat 2-5.

The base coat may be prepared by thermal curing. In addition to base resin polymers such as polyurethane and/or acrylics, the base coat may contain barium sulfate, pearl powder, metal powders, kaolin, talc, a dye, a color pigment, and/or combinations thereof, which are favorable for the color of the multi-layered sheet.

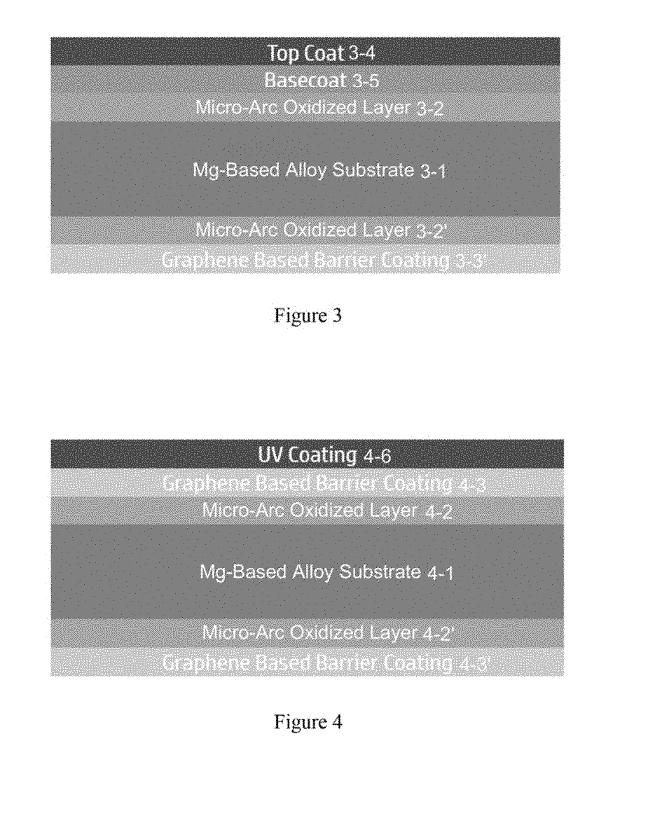

As can be seen from FIG. 3, it shows a specific example of one configuration of the multi-layered sheet of the present disclosure, which includes Mg-based alloy substrate 3-1, after being subjected to MAO surface treatment, micro-arc oxidized layer 3-2 and micro-arc oxidized layer 3-2′ are formed on two opposite surfaces of the Mg-based alloy substrate 3-1. Then, only one graphene-based barrier coating 3-3′ is formed on the micro-arc oxidized layer 3-2′. A base coat 3-5 is then prepared on the other micro-arc oxidized layer 3-2, and finally a top coat 3-4 is formed on the base coat 3-5.

As can be seen from FIG. 4, it shows a specific example of one configuration of the multi-layered sheet of the present disclosure, which includes Mg-based alloy substrate 4-1, after being subjected to MAO surface treatment, micro-arc oxidized layer 4-2 and micro-arc oxidized layer 4-2′ are formed on two opposite surfaces of the Mg-based alloy substrate 4-1. Then, graphene-based barrier coating 4-3 and graphene-based barrier coating 4-3′ are formed respectively on each micro-arc oxidized layer 4-2 and 4-2′. A UV coating 4-6 is then prepared on the graphene-based barrier coating 4-3, which neither comprises base coat, nor top coat.

UV coating in the present disclosures may comprise ultraviolet resins selected from the group consisting of polyols, polycarboxylic acids, polyamines, polyamides, acetoacetate, cyclic olefin copolymers, polymethylmethacrylate, polycarbonate, urethane acrylates, polyacrylate, polystyrene, polyetheretherketone, polyesters, polysulfone, parylene, fluoropolymers, and a combination thereof.

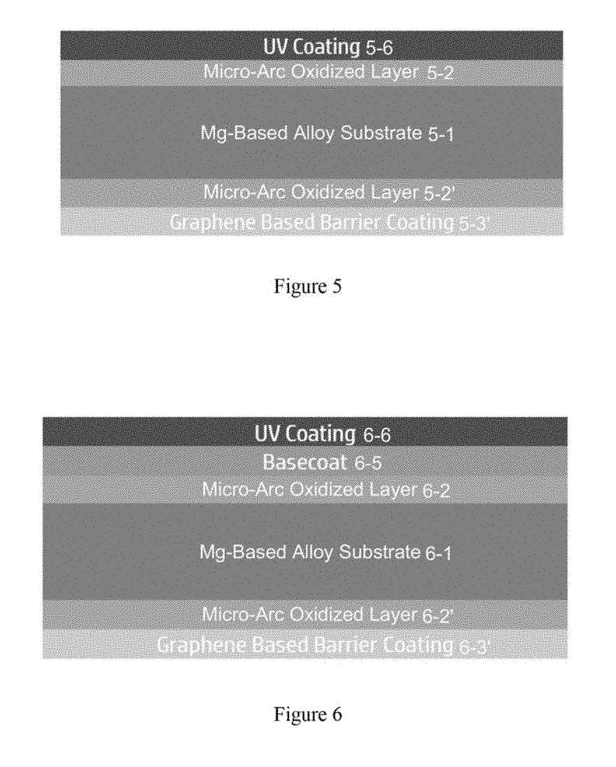

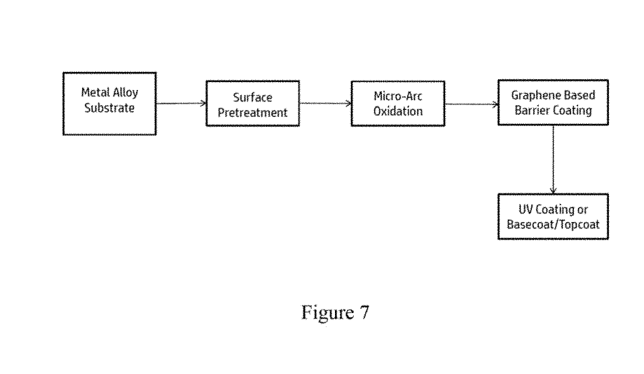

As can be seen from FIG. 5, it shows a specific example of one configuration of the multi-layered sheet of the present disclosure, which includes Mg-based alloy substrate 5-1, after being subjected to MAO surface treatment, micro-arc oxidized layer 5-2 and micro-arc oxidized layer 5-2′ are formed on two opposite surfaces of the Mg-based alloy substrate 5-1. Then, only one graphene-based barrier coating 5-3′ is formed on the micro-arc oxidized layer 5-2′. Finally, a UV coating 5-6 is prepared on the other one micro-arc oxidized layer 5-2, which neither comprises base coat, nor top coat.

As can be seen from FIG. 6, it shows a specific example of one configuration of the multi-layered sheet of the present disclosure, which includes Mg-based alloy substrate 6-1, after being subjected to MAO surface treatment, micro-arc oxidized layer 6-2 and micro-arc oxidized layer 6-2′ are formed on two opposite surfaces of the Mg-based alloy substrate 6-1. Then, only one graphene-based barrier coating 6-3′ is formed on the micro-arc oxidized layer 6-2′. A base coat 6-5 is then prepared on the other one micro-arc oxidized layer 6-2. Finally, a UV coating 6-6 is applied onto the base coat 6-5.

In the present disclosure, a process for preparing the multi-layered sheet is also provided, which comprises:

carrying out micro-arc oxidation on the Mg-based alloy substrate after an ordinary surface pretreatment to the Mg-based alloy substrate, so as to obtain micro-arc oxidized layers formed at least on two opposite surfaces of the Mg-based alloy substrate;

applying graphene-based barrier coating on either one or both micro-arc oxidized layers, wherein the graphene-based barrier coating comprises 20-70 wt % of graphene based on the total weight of the graphene-based barrier coating.

In some examples of the present disclosure, a process for preparing the multi-layered sheet may further comprising applying a base coat on the graphene-based barrier coating, or the micro-arc oxidized layer.

In some examples of the present disclosure, a process for preparing the multi-layered sheet may further comprising applying a top coat and/or a UV coating on the graphene-based barrier coating, the micro-arc oxidized layer, or the base coat.

The following non-limiting examples illustrate various features and characteristics of the present disclosure, and do not constitute any restrictions to the scope of the present disclosure.

The preparation and characterization of the multi-layered sheet samples No. 1-6 according to the present disclosure.

Multi-layered sheet samples No. 1-6 respectively correspond to the configurations shown in FIGS. 1 to 6, and the characterization of each layer in these samples was summarized in Table 1.

Samples No. 1-6 indicated in Table 1 were prepared by the following process: surface pre-treating Mg AZ 91;

carrying out micro-arc oxidation on the Mg AZ 91 till to obtain two micro-arc oxidized layers each having a thickness as indicated in Table 1, wherein a voltage in the range of 150-450 V was applied for about 3-20 minutes, and the electrolyte was sodium silicate, potassium hydroxide and sodium fluorozirconate, with a concentration of around 10-12% by weight;

applying graphene-based barrier coating on either one or both micro-arc oxidized layers by spray coating (Samples No. 1-3) or by dip coating (Samples No. 4-6) as indicated in Table 1, wherein the graphene-based barrier coating had a composition and a thickness as indicated in Table 1;

applying a base coat on the graphene-based barrier coating or the micro-arc oxidized layer in accordance with Table 1;

applying a top coat on the graphene-based barrier coating, or the base coat in accordance with Table 1; and

applying UV coating on the graphene-based barrier coating, the micro-arc oxidized layer, or the base coat in accordance with Table 1.

TABLE 1

| | Sample No. 1 | Sample No. 2 | Sample No. 3 |
|---|---|---|---|
| Mg-based alloy | MgAZ91¹⁾ | MgAZ91 | MgAZ91 |
| substrate | | | |
| Micro-are oxidized | Thickness: | Thickness: | Thickness: |
| layer | 15 μm | 3 μm | 5 μm |
| Graphene-based | 70 wt % of graphene²⁾; | 60 wt % of graphene; | 50 wt % of graphene; |
| barrier coating | 30 wt % of epoxy resin | 40 wt % of acrylic resin | 50 wt % of polyurethane |
| | (10P30-5); | (Dulux Lifemaster | resin (SC-J-C-C320452 |
| | Thickness: 15 μm | 59311): | from AKZO); |
| | | Thickness: 10 μm | Thickness: 15 μm |
| Base coat | — | acrylic urethane hybrid | acrylic urethane hybrid |
| | | resin (Interthane ® 990) | resin (Interthane ® 990) |
| | | Talc | Pigment aluminum |
| | | Thickness: 12 μm | powder |
| | | | Thickness: 7 μm |
| Top coat | acrylic urethane hybrid | acrylic urethane hybrid | acrylic urethane hybrid |
| | resin (200 Acrylic | resin (200 Acrylic | resin (200 Acrylic |
| | Urethane) | Urethane) | Urethane) |
| | Silica | fluoroacrylate | fluorourethane |
| | Thickness: 17 μm | Thickness: 20 μm | Thickness: 15 μm |
| UV coating | — | — | — |

| | Sample No. 4 | Sample No. 5 | Sample No. 6 |
|---|---|---|---|
| Mg-based alloy | MgAZ91 | MgAZ91 | MgAZ 91 |
| substrate | | | |
| Micro-are oxidized | Thickness: | Thickness: | Thickness: |
| layer | 10 μm | 25 μm | 20 μm |
| Graphene-based | 40 wt % of graphene; | 30 wt % of graphene; | 20 wt % of graphene; |
| barrier coating | 60 wt % of acrylic | 70 wt % acrylic | 80 wt % of epoxy resin |
| | resin (Dulux | urethane hybrid resin | (10P30-5); |
| | Lifemaster 59311): | (SC-J-B320760 from | Thickness: 5 μm |
| | Thickness: 12 μm | AKZO); | |
| | | Thickness: 5 μm | |
| Base coat | — | — | ECO-COAT(901-ZJS- |
| | | | 9341) |
| | | | Pearl powder |
| | | | Thickness; 9 μm |
| Top coat | — | — | — |
| UV coating | polyurethane UV coat | polyurethane UV coat | polyurethane UV coat |
| | (Aerodur ® Clearcoat | (Aerodur ® Clearcoat | (Aerodur ® Clearcoat |
| | UVR) | UVR) | UVR) |
| | Thickness: 15 μm | Thickness: 18 μm | Thickness: 14 μm |

¹⁾MgAZ 91 mainly contains about 9% Al, about 1% Zn and about 90% Mg by weight.
²⁾Graphene, from Ritedia (RDG27L5La)

The pencil hardness test for the above prepared multi-layered sheet samples No. 1-6 as shown in Table 2

Pencil hardness, by a series of pencils having different hardness maybe from 6B to 8H, is measured according to the (Standard ASTM D3363).

Samples No. 1 was placed on a level, firm, horizontal surface. Starting with the hardest lead, the pencil or lead holder was held firmly with the lead against the film at a 45° angle (point away from the operator) and pushed away from the operator. The load weight (750 g) was allowed to apply uniform pressure downward and forward as the pencil was moved to either to cut or scratch the film or to crumble the edge of the lead. It is suggested that the length of the stroke be ¼ in (6.5 mm). The process down the hardness scale was repeated until a pencil is found that will not scratch or gouge the film. The hardest pencil that does not scratch or gouge the film is then considered the pencil hardness of the sample.

The above test was repeated for multi-layered sheet Samples No. 2-5. The results of the pencil hardness for multi-layered sheet Samples No. 1 to 6 were summarized in Table 2.

TABLE 2

Sample No.

| | 1 | 2 | 3 | 4 | 5 | 6 |
|---|---|---|---|---|---|---|
| Pencil | 3H | 4H | 3H | 4H | 5H | 5H |
| Hardness | | | | | | |

The stain and solvent resistance test for the above prepared multi-layered sheet samples No. 1-6

The purpose of this test is to ensure the surface of the multi-layered sheet can withstand typical customer environment.

A visual inspection of the outside surfaces of the sample was conducted to ensure class requirements are achieved.

The following stains were purposely splashed onto the surfaces of the multi-layered sheet samples No. 1 to 6 and left in place for 30 mins.

Lipstick (Red)

Coffee (Nestle 3 in 1) prepared as direction, 60° C.

Yellow Mustard

Water Soluble Ink

Wax Pencil (Black)

Red Wine—no preference

Beer—Heineken

Regular Coca-Cola

Sunscreen—Coppertone, SPF 15

Lotion—Nivea

Artificial Sweat (PH4.7 & PH8.7)

It was found that all these stains can easily be removed with soft cloth after the indicated time period from the surfaces of the multi-layered sheet samples No. 1 to 6.

Solvent resistance test was performed on the multi-layered sheet samples No. 1 to 6 according to ASTM D 5402 (Standard Practice for Assessing the Solvent Resistance of Organic Coatings Using Solvent Rubs).
Ethanol (75% Alcohol)
Cheese Cloth (Mesh Grade 28×24; Grade 50 from testfabric.com): 300 mm×300 mm
Taper Linear Abraser with Crockmeter Kit (16 mm diameter acrylic rubbing finger) for sleeve pack testing and square kit

It was found that all samples No. 1 to 6 would not be dissolved and washed off by the solvent and no marks would be left on the surface and therefore they all have satisfactory solvent resistance in the test.

What is claimed is:

1. A multi-layered sheet comprising:
Mg-based alloy substrate;
micro-arc oxidized layers formed on two opposite surfaces of the Mg-based alloy substrate; and
graphene-based barrier coating formed on either one or both of the micro-arc oxidized layers;
wherein the graphene-based barrier coating comprises 20-70 wt % of graphene based on the total weight of the graphene-based barrier coating.

2. A multi-layered sheet in accordance with claim 1, wherein the graphene-based barrier coating has a thickness of 5 to 15 μm and/or the micro-arc oxidized layer has a thickness of 3 to 25 μm.

3. A multi-layered sheet in accordance with claim 1, wherein the graphene-based barrier coating comprises one or more polymers selected from the group consisting of epoxy-based polymers, acrylics polymers, polyurethane, acrylic-polyurethane hybrid polymers, and fluorine-containing polymers.

4. A multi-layered sheet in accordance with claim 1, wherein the graphene-based barrier coating is prepared by spray coating or by dip coating.

5. A multi-layered sheet in accordance with claim 1, wherein the multi-layered sheet further comprises a base coat and/or a top coat.

6. A multi-layered sheet in accordance with claim 5, wherein the base coat comprises a component selected from the group consisting of barium sulfate, pearl powder, metal powders, kaolin, talc, dye, pigment, and combinations thereof.

7. A multi-layered sheet in accordance with claim 5, wherein the top coat comprises a component selected from the group consisting of silica and fluoropolymers.

8. A multi-layered sheet in accordance with claim 7, wherein the fluoropolymers comprise poly(vinylidene fluoride), polytetrafluoroethylene, fluorinated olefin-based polymers, fluoroacrylates, fluorosilicone acrylates, fluorourethanes, perfluoropolyethers, perfluoropolyoextanes, fluorotelomers (C-6 or lower), fluorosiloxane and/or fluoro UV polymers.

9. A multi-layered sheet in accordance with claim 1, wherein the multi-layered sheet further comprises UV coating.

10. A multi-layered sheet in accordance with claim 9, wherein the UV coating comprises resins selected from the group consisting of polyols, polycarboxylic acids, polyamines, polyamides, acetoacetate, cyclic olefin copolymer, polymethylmethacrylate, polycarbonate, urethane acrylates, polyacrylate, polystyrene, polyetheretherketone, polyesters, polysulfone, parylene, fluoropolymers, and a combination thereof.

11. A multi-layered sheet in accordance with claim 1, wherein the multi-layered sheet has a pencil hardness of 3H or more.

12. A process for preparing a multi-layered sheet of claim 1, which comprises:
carrying out micro-arc oxidation on the Mg-based alloy substrate to obtain micro-arc oxidized layers formed on two opposite surfaces of the Mg-based alloy substrate; and
applying graphene-based barrier coating on either one or both micro-arc oxidized layers, wherein the graphene-based barrier coating comprises 20-70 wt % of graphene based on the total weight of the graphene-based barrier coating.

13. A process in accordance with claim 12, wherein it further comprises applying a base coat on the graphene-based barrier coating or the micro-arc oxidized layer.

14. A process in accordance with claim 13, wherein it further comprises applying a top coat and/or a UV coating on the graphene-based barrier coating, the micro-arc oxidized layer, or the base coat.

15. Use of the multi-layered sheet according to claim 1, wherein the multi-layered sheet is used as a housing of laptop, tablet PC, desktop computer, smart phone and 3C electronic devices.
